(19) United States
(12) Patent Application Publication
(10) Pub. No.: US 2025/0379408 A1
(43) Pub. Date: Dec. 11, 2025

(54) DIVERTING DEVICE FOR DIVERTING ELECTRICAL CURRENTS, AND MACHINE COMPRISING A DIVERTING DEVICE OF THIS TYPE

(71) Applicant: Schunk Carbon Technology GmbH, Bad Goisern (AT)

(72) Inventor: Stephen Matthey, Abersee (AT)

(21) Appl. No.: 18/876,808

(22) PCT Filed: Jun. 19, 2023
(86) PCT No.: PCT/EP2023/066464

§ 371 Date: Dec. 19, 2024

(30) Foreign Application Priority Data
Jun. 20, 2022 (DE) 10 2022 115 223.5

(51) Int. Cl. H01R 39/26; H01R 39/38; H01R 39/56; H02K 11/40

(52) U.S. Cl. CPC H01R 39/26; H01R 39/381; H01R 39/388; H01R 39/56; H02K 11/40

(57) ABSTRACT

A discharge device for discharging electric currents from a rotor part of a machine having a shaft. The discharge device has a displaceable contact element received at least partially in a guide unit and serving to form an electrically conductive sliding contact between a sliding contact surface of the contact element provided for forming the sliding contact and a shaft contact surface, the contact element being connected to the guide unit and/or a retaining element of the machine in an electrically conductive manner and the contact element being pre-loaded towards the shaft contact surface by a spring element, the contact element being wetted at least partially by a lubricating and cooling fluid, the guide unit comprising a guiding part for receiving the contact element and a retaining part for receiving the guiding part, the retaining part and the guiding part forming a duct for the lubricating and cooling fluid.

### CROSS-REFERENCE TO RELATED APPLICATIONS

This patent application is a national stage application of International Patent Application No. PCT/EP2023/066464 filed Jun. 19, 2023, which claims priority to German Patent Application No. 10 2022 115 223.5 filed Jun. 20, 2022, the disclosures of which is incorporated herein by reference in its entirety for all purposes.

### TECHNICAL FIELD

This disclosure relates to a discharge device for discharging electric currents.

### BACKGROUND

Discharge devices for discharging electric currents are known from the state of the art in various embodiments. In particular, it is known to use carbon brushes for discharging low-frequency currents, these carbon brushes being disposed in an axial or radial distribution around a shaft and being connected to a stator via connecting wires. Due to their low electrical resistance, the carbon brushes, which are received in a retaining unit and/or brush holder, allow electrical currents to be discharge discharged directly and can therefore avoid undesired current conduction via bearing points of the shaft and/or transmission connections, such as gear wheels or similar, which could lead to surface damage to the bearing bodies or bearing rings due to spot welding.

The term “shaft” is used here as a synonym for the term “rotor part” or “axle”. Therefore, the term “shaft” refers to all rotating machine parts for which currents can be discharged to a stationary stator part and/or machine part of a machine.

Discharge devices are also regularly used in railroad technology, where alternating currents or even an operating current can flow via wheel axles. Discharge devices of this type are described in DE 10 2010 039 847 A1, for example.

Measures to discharge currents are also required for electrical machines in general, for example for motor vehicles. Continuously fluctuating alternating voltages and/or currents and high-frequency current pulses can occur in motor drive shafts or connected transmission shafts and/or other functional components and can also damage bearing points of a rotor shaft or transmission shaft, for which reason discharge devices are regularly required here.

One problem with the discharge devices described and the machines having such discharge devices is the high heat development caused by electrical and mechanical losses, which leads to high thermal loads on both the discharge device and the machine (e.g., motor, transmission). In order to manage this problem to a certain extent, ventilation systems have hitherto been used to dissipate the generated heat. However, such ventilation systems can only partially minimize the thermal load on components. A further disadvantage of such ventilation systems is the drastic increase in the installation space required to integrate such ventilation systems into the machines in question.

In order to minimize the disadvantages mentioned, WO 2022/135715 A1 proposes wetting the contact element in the area of its sliding contact surface with a lubricating and cooling fluid. In this manner, capacitively coupled high-frequency voltages (so-called parasitic alternating voltages), which are formed by electric drives due to the power electronics used (pulse width modulation), are discharged and at the same time the heat generated in this process is contained or discharged with the aid of the lubricating and cooling fluid. No special cooling device, such as a ventilation system, is required to minimize the thermal load. As a result, the design of a machine, such as an electric motor, can be simpler and therefore less expensive and the cooling of the motor more efficient than with previously known systems. For example, friction losses caused by radial shaft seals, among other things, are also eliminated. In addition—as already mentioned above—the overall machine dimensions can be smaller (moment of inertia of the rotating parts is reduced).

This known discharge device has an axial fluid guide in the form of an axial channel which opens into the space between the shaft and the guide unit.

This discharge device having axial fluid flow has the disadvantage that, for a given volume flow, the output depends on the cross-sectional area and the flow velocity of the fluid. At very high volume flows, the cross-sectional area may be too small and/or the flow velocity too high. The disadvantage is therefore that often not enough fluid reaches the area between the shaft and the guide unit for cooling. Furthermore, the known guide units are somewhat complicated and cost-intensive to manufacture.

### SUMMARY

The object of the disclosure is therefore to overcome the disadvantages of the state of the art.

According to the disclosure, this object is attained by a discharge device of the make mentioned above which is characterized in that the guide unit comprises a guiding part for receiving the contact element and a retaining part for receiving the guiding part, the retaining part and the guiding part forming a duct for the lubricating and cooling fluid.

With the discharge device according to the disclosure, it is ideally possible to discharge capacitively coupled high-frequency voltages (so-called parasitic alternating voltages), which are formed by electric drives due to the power electronics used (pulse width modulation), and at the same time to contain and/or discharge the resulting heat with the aid of the lubricating and cooling fluid. In particular, the present disclosure does not require a special cooling device, such as a ventilation device, to minimize the thermal load. As a result, the design of a machine, such as an electric motor, can be simpler and therefore less expensive and the cooling of the motor can be made more efficient than with the systems known to date. For example, friction losses caused by radial shaft seals, among other things, are also eliminated. In addition—as mentioned above—the overall machine dimensions can be smaller (moment of inertia of the rotating parts is reduced).

As a rule, the lubricating and cooling fluid is an oily fluid, in particular engine and/or transmission oil, which is usually present anyway in the engine or transmission in which the discharge device according to the disclosure is provided.

The fact that the guide unit comprises a guiding part for receiving the contact element and a retaining part for receiving the guiding part, and that the retaining part and the guiding part form a duct for the lubricating and cooling fluid makes it possible to create fluid ducts in a wide variety of shapes and sizes in a simple manner. For instance, a fluid duct can be produced extremely simply by integrating a guiding part having an outer circumference which deviates from a cylindrical shape into a retaining part having a cylindrical recess. This inevitably results in cavities whose shape and size can be determined by adapting the outer circumference of the guiding part accordingly.

As a rule, the fluid duct extends at least along the guiding part, the fluid duct extending preferably along the entire length of the guiding part. This achieves excellent cooling of the rotor in a particularly advantageous manner. In this embodiment, the lubricating and cooling fluid can flow over the entire length of the guiding part into the space between the shaft and the contact element.

Advantageously, the duct for the lubricating and cooling fluid is formed by a longitudinal recess in an outer wall of the guiding part and/or a longitudinal recess in an inner wall of the retaining part, which contacts the outer wall of the guiding part. Such longitudinal recesses make it extremely easy to manufacture a fluid duct.

In a particularly preferred embodiment of the discharge device according to the disclosure, an inner wall of the retaining part is cylindrical and the outer wall of the guiding part has a shape deviating from a cylindrical shape, preferably has a cross section deviating from a round shape, at least one, preferably three or four, grooves extending in the longitudinal direction of the guiding part, and in particular having a semicircular cross section, being provided in the outer circumference of the guiding part. This embodiment is particularly easy to manufacture and is characterized by simple flexibility in the creation of fluid ducts of different shapes and sizes. In this manner, fluid ducts can be manufactured by means of which large quantities of oil can be transported to the locations to be cooled.

In a further embodiment of the discharge device according to the disclosure, the outer wall of the guiding part has an essentially round cross section and is preferably cylindrical, the inner wall of the retaining part having a shape deviating from a cylindrical shape, preferably having a cross section deviating from a round shape. The embodiments described are therefore characterized by essentially cuboidal or triangular prismatic guiding parts, the sides of which are curved inwards, i.e., are concave. These guiding parts can be manufactured particularly advantageously by extrusion or continuous casting and form optimum fluid ducts with the retaining part.

In a further embodiment of the discharge device according to the disclosure, the outer wall of the guiding part has an essentially round cross section and is preferably cylindrical, the inner wall of the retaining part having a shape deviating from a cylindrical shape, preferably having a cross section deviating from a round shape. This embodiment can also be used to create fluid ducts of different shapes and sizes in a simple manner.

Advantageously, the guiding part is an extruded profile, preferably an aluminum extruded profile or a continuous casting profile. Such guiding parts are particularly easy and inexpensive to manufacture.

At least one fluid duct in the shape of a channel is provided in the guiding part, the channel preferably opening in a front face of the guiding part, the front face defining the space between the shaft and the discharge device. With this embodiment, even more lubricating and cooling fluid can be directed to the location to be cooled. This fluid duct can, for example, be a duct extending parallel to the longitudinal axis of the discharge device, such as a fluid guide channel.

Advantageously, the guiding part is essentially completely received in the retaining part. This makes it possible to create a duct channel for the lubricating and cooling fluid which extends along the entire length of the guiding part. This fluid can then flow into the space between the shaft and the discharge device.

In a particularly preferred embodiment of the discharge device according to the disclosure, the guide unit is connectable to a stator part of the machine in an electrically conductive manner. This stator part of the machine can, for example, serve as a retaining device for the discharge device. When the current is discharged, it is discharged from the relevant shaft into the contact element and the guide unit of the discharge device. The discharged current then flows into said stator part of the machine in the embodiment described.

Advantageously, the contact element is connected to the guide unit in an electrically conductive manner by means of a, preferably low-impedance, stranded wire, the stranded wire preferably being pressed or stamped into the contact element at one end and preferably being welded or soldered or crimped to the guide unit at the other end. The guide unit is preferably at least partially made of a low-impedance material, in particular plastic or metal, preferably aluminum, aluminum alloy, copper and/or brass.

In a particularly preferred embodiment of the discharge device according to the disclosure, the contact element is essentially made of a carbon-metal mixture, in particular of a mixture of graphite and an electrically highly conductive metal, silver preferably being the provided metal at least in the area of the sliding contact surface of the contact element and copper preferably being the provided metal in a rear area of the contact element, the contact element preferably being free of copper in the area of the sliding contact surface. The portion of metal in the contact element is preferably at least 30% by volume. In the area of the sliding contact surface, the contact element is therefore preferably free of copper, as this metal can lead to catalytic changes in the lubricating and cooling fluid in conjunction with the passage of current, which can consequently negatively change the physical properties of this fluid. For this reason, the shaft of the machine according to the disclosure described in more detail below is also free of copper, at least in the area where the shaft contacts the contact element.

In order to keep the system resistance as low as possible under all operating conditions, the resistance of the discharge device according to the disclosure should also be low. The resistance of the entire device can be kept low by using the embodiments described above with low-impedance materials and a contact element made of a metal-carbon mixture. On the other hand, the system resistance is significantly influenced by the voltage drop between the shaft surface and the sliding contact surface of the contact element. This takes up the largest portion of the overall system. It should therefore also be kept low. To ensure this under continuous lubrication, a high specific contact pressure of the contact element on the shaft is advantageous. This value should be at least 10 N/cm². On the other hand, no electrochemical reactions should occur on the contact element in the area of the sliding contact surface in conjunction with the lubricating and cooling fluid. This is ensured particularly by a silver-graphite material in an area of the contact element subject to wear over the entire service life.

Advantageously, the contact element has a recess, in particular a drill hole or slot, in the area of the sliding contact surface. This prevents the contact from floating on the oil film. Advantageously, the contact element is open-pored in the area of the sliding contact surface. This contributes to the suppression of electrical contact losses between the shaft and the contact element and minimizes floating of the contact element on the oil film.

The contact element is typically a pin-or bolt-shaped brush. The sliding contact surface be rectangular, polygonal or circular. The brush is usually manufactured by compression molding and subsequent heat treatment.

Advantageously, the spring element can be a helical spring, one of whose ends abuts preferably against the front face of the contact element opposite the sliding contact surface. With a helical compression spring of this type, it is easy to press the contact element against the shaft using a specific desired contact pressure at all times.

The present disclosure also relates to a machine, in particular an electric drive motor or transmission having a rotor part having a shaft and a discharge device, the contact element of the discharge device contacting the shaft with its sliding contact surface in order to form a sliding contact. The machine according to the disclosure achieves the previously described advantages of a drastically reduced thermal load using a small installation size and uncomplicated design.

In the machine according to the disclosure, the discharge device can be mounted completely in the lubricating and cooling fluid, in particular motor or transmission oil. Preferably, the lubricating and cooling fluid is provided at least in a space between the shaft and the guide unit, which is bridged by the contact element. In this embodiment, the area where the greatest heat is generated, namely the area between the shaft and the contact element, is cooled by the lubricating and cooling fluid.

Advantageously, the contact element is always pressed against the shaft by the spring element using a force of at least 10 N/cm². This minimizes the voltage drop between the shaft surface and the sliding contact surface of the contact element.

As previously explained above, the shaft is preferably essentially free of copper at least in the area where it is contacted by the contact element.

In a preferred embodiment of the machine according to the disclosure, the contact element contacts a front face of the shaft, the contact element preferably being disposed essentially coaxially to the shaft. This type of shaft grounding is preferable for avoiding contact losses, as the axial runout of the rotating shaft is usually low. By positioning the contact element close to the shaft's point of rotation, the circumferential speeds are minimized and the actual running distance over the service life of the contact element is reduced enormously. This has a direct influence on the wear of the contact element, which usually correlates proportionally with the running distance. By minimizing the running distance, the wear of the contact element remains low, as a result of which the loss of force of the spring element over the total wear length of the contact element is also minimal. This makes it possible, for example, to use a low-cost helical compression spring as mentioned above. In addition, the low circumferential speed close to the shaft's axis of rotation reduces the risk of a continuous, electrically insulating lubricating film from forming, which means the contact pressure can be kept lower than would be necessary at high circumferential speeds. Another advantage of the frontal contacting of the shaft close to the axis of rotation is the minimization of the frictional torque due to the small radial distance from the point of rotation. Even with a very high frictional force, the frictional torque as the product of frictional force x running radius remains small. As a result, the friction power remains low in conjunction with the angular velocity (equivalent to the rotational speed) and the system losses remain small.

In a further embodiment of the machine according to the disclosure, the contact element contacts the jacket surface of the surface. In this embodiment, cross section of the contact element is preferably geometrically tapered towards the preferred direction of rotation of the shaft to be contacted in order to achieve suppression of electrical contact losses due to floating between the shaft and the contact element.

As a rule, the discharge device is positioned in a section of the machine where the primary operating temperature is above 50° C.

Further features of the disclosure are shown in the following descriptions of the figures in conjunction with the drawings and the dependent claims. The individual features can be realized alone or in combination with one another.

### BRIEF DESCRIPTION OF THE FIGURES

FIG. 1 shows a perspective view of a discharge device according to the disclosure having a guiding part and retaining part.

FIG. 2-FIG. 5 show guiding parts of further embodiments of discharge devices according to the disclosure.

FIG. 6 shows a perspective view of the guiding part of the discharge device of FIG. 1.

FIG. 7 shows a front view of the discharge device of FIG. 1.

FIG. 8 shows a longitudinal section through a machine according to the disclosure having the discharge device according to FIG. 1.

### DETAILED DESCRIPTION

In the following, identical or functionally identical elements are identified with the same reference numbers.

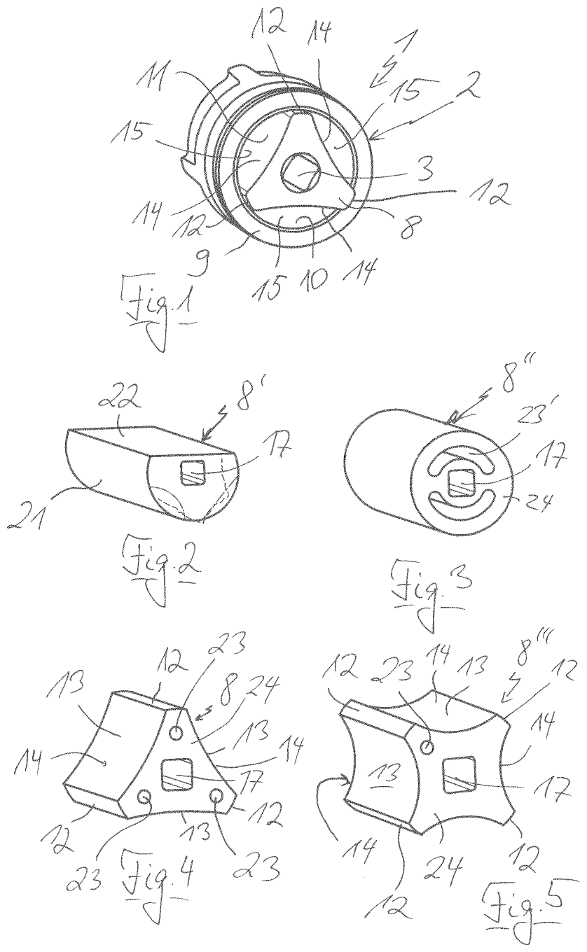

FIGS. 1, 7 and 8 show a discharge device 1 according to the disclosure, the discharge device 1 in FIG. 8 being integrated in a machine 100 according to the disclosure. The discharge device 1 is used to discharge electrical currents from a rotor part of a machine 100 having a shaft 5. The discharge device 1 comprises a pin-shaped and displaceable brush 3 received in a guide unit 2 and serving to form an electrically conductive sliding contact between a sliding contact surface 4 of the brush 3 provided for forming the sliding contact and a shaft contact surface 6 of the shaft. The shaft 5 is shown in FIG. 8. The brush 3 is pre-loaded towards the shaft contact surface 6 by means of a helical compression spring 7. This can also be seen in FIG. 8. In the area of the sliding contact surface 4, the brush 3 is wetted by means of a lubricating and cooling fluid.

The guide unit 2 comprises a guiding part 8 for receiving the brush 3 and a retaining part 9 for receiving the guiding part 8. In the example shown, the inner wall 10 of the retaining part 9 is cylindrical in shape. The outer wall 11 of the guiding part 8, on the other hand, has a shape which differs from a cylindrical shape. For instance, the guiding part 8 is designed as a kind of triangular prism, the cross section of the guiding part 8 essentially being triangular and having flattened corners 12, the sides of the triangle being curved inwards, i.e., being concave. Due to the side surfaces 13 of the guiding part 8, which are thus also concave, the guiding part 8 has three semi-circular grooves 14 extending in the longitudinal direction of the guiding part 8. These grooves 14 extend along the entire length of the guiding part 8.

As can be clearly seen in FIGS. 1, 7 and 8, the guiding part 8 is received in the retaining part 9 and its flattened corners 12 contact the inner wall 10 of the retaining part 9. In this context, the grooves 14 in the outer circumference of the guiding part 8 form a total of three fluid ducts 15 in conjunction with the inner wall 10 of the retaining part 9. These fluid ducts 15 serve as flow channels for the lubricating and cooling fluid, which flows from a rear side 16 of the discharge device 1 in the direction of the sliding contact surface 4 of the brush 3.

A continuous receiving channel 17 for the brush 3 is also provided in the guiding part 8. Both the brush 3 and the receiving channel 17 have an essentially square cross section with rounded corners.

As can be seen in FIG. 8, on the side of the guide unit 2 facing the shaft 5, the brush 3 slightly protrudes from the guiding part 8 and contacts the shaft 5 at its end face 18. In this context, the brush 3 is disposed essentially centrally to the end face 18 of the shaft and thus coaxially to the shaft 5.

At the other end of the guiding part 8, it has a cover 19 to which a strand 20 is attached. The spring 7, which preloads the brush 3 towards the shaft 5, is disposed between the cover 19 and the brush 3. The strand 20 is made of a low-impedance material and is pressed into the brush 3 at one end and connected to the cover 19 at its other end.

The brush is made of a graphite-metal mixture.

FIGS. 2, 3 and 5 show other possible shapes of guiding parts. FIG. 2 shows a guiding part 8′, which has a semi-circular cross section, whereby a flat surface 22 adjoins a curved jacket surface 21. Received in the retaining part 9 with cylindrical inner wall 10 from FIG. 1, the inner wall 10 of the retaining part 9 forms a fluid duct in conjunction with the flat surface 22 of the guiding part 2′. The lines indicated in FIG. 2 are intended to show that further longitudinal grooves can be made in the curved surface 21, the longitudinal grooves being able to form further fluid ducts in conjunction with the inner wall 10 of the retaining part 9.

FIG. 3 shows a further embodiment of a guiding part 8″ having a round cross section. The guiding part 8″ is particularly suitable for retaining parts which have an inner-wall cross section which deviates from a round shape. For instance, the guiding part 8″ would thus form four fluid ducts in a retaining part having a cuboidal body and an inner wall having a square cross section.

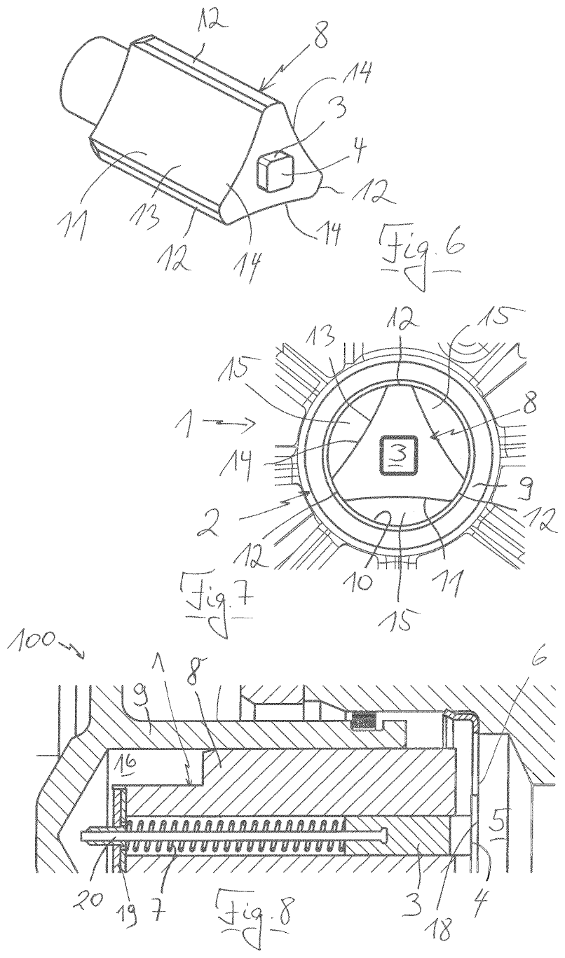

FIG. 5 shows a further embodiment of a guiding part 8′″. The guiding part 8′″ can be combined with the retaining part 9 of FIG. 1. The guiding part 8′″ has a square cross section and flattened corners 12, the sides of the square being concave. The guiding part 8′″ thus has an essentially cuboidal shape, the side surfaces 13 of the cuboid being concave. If the guiding part 8′″ is integrated in the retaining part 9, the concave side surfaces 13 thus form a total of four fluid ducts in conjunction with the cylindrical inner circumference 10 of the retaining part 9.

FIG. 4 shows a guiding part corresponding in shape to the guiding part 8 of FIG. 1, but differs from the guiding part 8 of FIG. 1 only in that it has three continuous fluid ducts 23 with a round cross-section. These fluid ducts extend along the entire length of the guiding part 8 and serve to transport even more lubricating and cooling fluid into the space between the shaft 5 and the guiding part 8. The guiding part 8′″ in FIG. 5 also has a duct of this type. The guiding part 8′″ in FIG. 3 also has two such ducts 23′, each of which has a longitudinal, curved cross section. The ducts 23, 23′ each open in a front face 24 of the respective guiding part.

The shown guiding parts 8, 8′, 8″ and 8′″ are all aluminum-extruded profiles.

1. A discharge device for discharging electric currents from a rotor part of a machine having a shaft, the discharge device comprising a displaceable contact element received at least partially in a guide unit and serving to establish an electrically conductive sliding contact between a sliding contact surface of the contact element provided for forming the sliding contact and a shaft contact surface of the shaft, the contact element being connected to the guide unit and/or a retaining element of the machine in an electrically conductive manner and the contact element being pre-loaded towards the shaft contact surface by a spring element,
the contact element being wetted at least partially, in particular at least in the area of its sliding contact surface, by a lubricating and cooling fluid,
wherein
the guide unit comprises a guiding part for receiving the contact element and a retaining part for receiving the guide part, the retaining part and the guiding part forming a duct for the lubricating and cooling fluid.

2. The discharge device according to claim 1,
wherein
the fluid duct extends at least along the guiding part.

3. The discharge device according to claim 1,
wherein
the fluid duct is formed by a longitudinal recess in an outer wall of the guiding part and/or a longitudinal recess in an inner wall of the retaining part, which contacts the outer wall of the guiding part.

4. The discharge device according to claim 1,
wherein
an inner wall of the retaining part is cylindrical and the outer wall of the guiding part has a shape deviating from a cylindrical shape.

5. The discharge device according to claim 1,
wherein
the cross section of the guiding part is essentially triangular or square and has flattened or rounded corners.

6. The discharge device according to claim 1,
wherein
the outer wall of the guiding part has an essentially round cross section, the inner wall of the retaining part having a shape deviating from a cylindrical shape.

7. The discharge device according to claim 1,
wherein
the guiding part is an extruded profile.

8. The discharge device according to claim 1,
wherein
at least one fluid duct in the shape of a channel is provided in the guiding part.

9. The discharge device according to claim 1,
wherein
the guiding part is essentially completely received in the retaining part.

10. The discharge device according to claim 1,
wherein
the guiding part is connectable to a stator part of the machine in an electrically conductive manner.

11. The discharge device according to claim 1,
wherein
the contact element is a pin-or bolt-shaped brush.

12. The discharge device according to claim 1,
wherein
the spring element is a helical spring.

13. A machine, in particular an electric drive motor or transmission having a rotor part having a shaft and a discharge device according to claim 1, the contact element of the discharge device contacting the shaft with its sliding contact surface in order to form a sliding contact.

14. The machine according to claim 13,
wherein
lubricating and cooling fluid, in particular motor or transmission oil, or a water-based cooling medium is provided at least in a space between the shaft and the guide unit, which is bridged by the contact element.

15. The machine according to claim 13,
wherein
the contact element contacts a front face of the shaft.

16. The machine according to any one of the claims 13,
wherein
the contact element contacts a jacket surface of the shaft.

17. The discharge device according to claim 2,
wherein
the fluid duct extends along the entire length of the guiding part.

18. The discharge device according to claim 4,
wherein
the outer wall of the guiding part has a cross section deviating from a round shape, has at least one groove extending in the longitudinal direction of the guiding part, and has a semicircular cross section being provided in the outer circumference of the guiding part.

19. The discharge device according to claim 7,
wherein
the extruded profile is an aluminum extruded profile or a continuous casting profile.

20. The discharge device according to claim 8,
wherein
the channel opening in a front face of the guiding part.
